(19) United States
(12) Patent Application Publication
(10) Pub. No.: US 2017/0346339 A1
(43) Pub. Date: Nov. 30, 2017

(54) INDUCTIVE POWER TRANSFER SYSTEM

(71) Applicant: PowerbyProxi Limited, Freemans Bay, Auckland (NZ)

(72) Inventor: Lawrence Bernardo DELA CRUZ, Freemans Bay, Auckland (NZ)

(73) Assignee: PowerbyProxi Limited, Freemans Bay, Auckland (NZ)

(21) Appl. No.: 15/524,881

(22) PCT Filed: Nov. 4, 2015
(86) PCT No.: PCT/NZ2015/050184

§ 371 Date: May 5, 2017

Related U.S. Application Data
(60) Provisional application No. 62/076,291, filed on Nov. 6, 2014.

(51) Int. Cl. H02J 50/10; H02M 1/34; H04B 5/00

(52) U.S. Cl. CPC H02J 50/10; H04B 5/0093; H02M 1/34; H04B 5/0037; H02M 2001/344

(57) ABSTRACT

An inductive power transfer transmitter 200 comprising: a transmitting coil 7; a main flyback switch S1 in series with the transmitting coil 7; and an active snubber circuit 202 connected in parallel with the main flyback switch S1; wherein the main flyback switch S1 and the active snubber circuit 202 are configured to provide substantially zero voltage switching

### FIELD OF THE INVENTION

This invention relates generally to an inverter and/or an inductive power transfer (IPT) system.

### BACKGROUND OF THE INVENTION

In an IPT system typically an inverter provides an AC voltage to a transmitting coil. The coil generates a magnetic field, which is coupled to a receiver coil to transfer power. Various different inverter topologies are currently contemplated for IPT. For example a push pull topology is disclosed in International Patent Publication number WO2007/015651. However in some IPT applications where size of the converter is important, a push pull topology is less desirable because the push pull inductors may take up a lot of space, may make the design relatively expensive and/or efficiency may be reduced (if frequency is increased to reduce the inductor size).

In other applications outside of IPT, flyback converters have been used, especially in higher voltage lower current scenarios. However while flyback converters have not been extensively researched in the IPT context, most implementations typically involve hard switching (meaning the efficiency is lower due to switching losses) and/or the operating frequency is subject to significant variation based on the load or coupling conditions.

For example Texas Instruments Literature Number: SLUP262 (2010 Texas Instruments Power Supply Design Seminar SEM1900, Topic 2) discloses an improved flyback converter with an active clamp for a low power “Power-over-Ethernet” circuit. The active clamp Q2 (and associated capacitor) allows the primary switch Q1 to operate in a quasi Zero Voltage Switching (ZVS) manner in this application. However this design cannot be readily applied to the IPT field because the output capacitance C_{OSS} of Q1 in FIG. 4a would be insufficient to support ZVS during normal operation, due to the wide band of operating conditions encountered in IPT. Also as Q1 is switched using closed loop control over V_{OUT}, the operating frequency would not be stable.

It is therefore an object of the present invention to provide the public with a useful choice.

### SUMMARY OF THE INVENTION

According to one exemplary embodiment there is provided an inductive power transfer transmitter comprising:
a transmitting coil;
a main flyback switch in series with the transmitting coil; and
an active snubber circuit connected in parallel with the main flyback switch;
wherein the main flyback switch and the active snubber circuit are configured to provide substantially zero voltage switching.

According to a further exemplary embodiment there is provided an inductive power receiver comprising:
a resonant tank including a receiving coil and a resonance capacitor;
a power regulating circuit, and
a regenerative snubber connected to the power regulating circuit.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that those documents are prior art or form part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a block diagram of an inductive power transfer system;

FIG. 2 is a block diagram of an example transmitter;

FIG. 3 is a graph of the voltage across the transmitting coil for the transmitter in FIG. 2;

FIG. 4 is a block diagram of an example receiver; and

FIG. 5 is a circuit diagram of an example modified flyback converter.

### DETAILED DESCRIPTION OF EMBODIMENTS OF THE INVENTION

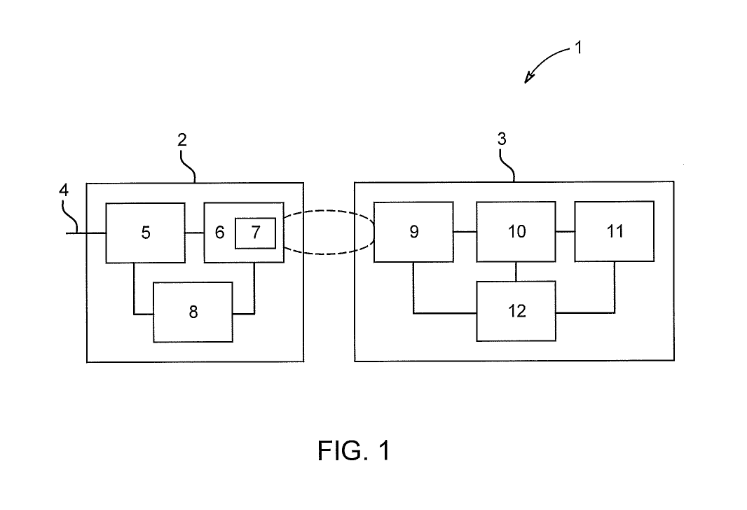

FIG. 1 shows a representation of an inductive power transfer (IPT) system 1. The IPT system includes an inductive power transmitter device 2 and an inductive power receiver device 3. The inductive power transmitter 2 is connected to transmitter circuitry which may include one or more of an appropriate power supply 4 (such as mains power) and an AC-DC converter 5 that is connected to an inverter 6. The inverter 6 of the transmitter circuitry supplies a transmitting coil or coils 7 with an AC signal so that the transmitting coil or coils 7 generate an alternating magnetic field. In some configurations, the transmitting coils 7 may also be considered to be separate from the inverter 6. The transmitting coil or coils 7 may be connected to capacitors (not shown) either in parallel or series to create a resonant circuit.

A controller 8 within the inductive power transmitter 2 may be connected to each part of the inductive power transmitter 2. The controller 8 may be adapted to receive inputs from each part of the inductive power transmitter 2 and produce outputs that control the operation of each part. The controller 8 may be implemented as a single unit or separate units. The controller 8 may be adapted to control various aspects of the inductive power transmitter 2 depending on its capabilities, including for example: power flow, tuning, selectively energising transmitting (transmitter) coils, inductive power receiver detection and/or communications.

The inductive power receiver 3 includes a receiving coil or coils 9 that is connected to receiver circuitry which may include power conditioning circuitry 10 that in turn supplies power to a load 11. When the coils 7,9 of the inductive power transmitter 2 and the inductive power receiver 3 are suitably coupled, the alternating magnetic field generated by the transmitting coil or coils 7 induces an alternating current in the receiving coil or coils. The power conditioning circuitry 10 converts the induced current into a form that is appropriate for the load 11. The receiving coil or coils 9 may be connected to (resonance) capacitors (not shown) either in parallel or series to create a resonant circuit. In some inductive power receivers, the receiver circuitry may further include a controller 12 which may, for example, control the tuning of the receiving coil or coils 9, the power supplied to the load 11 by the receiving circuitry and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. The use of the term “coil”, in either singular or plural, is not meant to be restrictive in this sense. Other configurations may be used depending on the application.

In certain applications it may be desirable to minimise the size of the transmitter 2 and/or receiver 3. For example the size of the inductors and/or the number of switches used may be a design objective. In such cases, a modified flyback converter may be employed according to an example embodiment.

In prior art flyback converters, typically the main switch on the primary side is controlled based on the secondary load voltage, to provide closed loop control. As a result with variations in the load the operating frequency varies considerably. In the IPT context this is important because the load varies considerably.

In the example embodiment the power switch in the transmitter is controlled in an open loop fashion, to provide substantially zero voltage switching of the power switch and/or a substantially stable operating frequency. This may be achieved by modifying the typical flyback primary circuit to include an active clamp, and a resonant capacitor, both in parallel with the main switch.

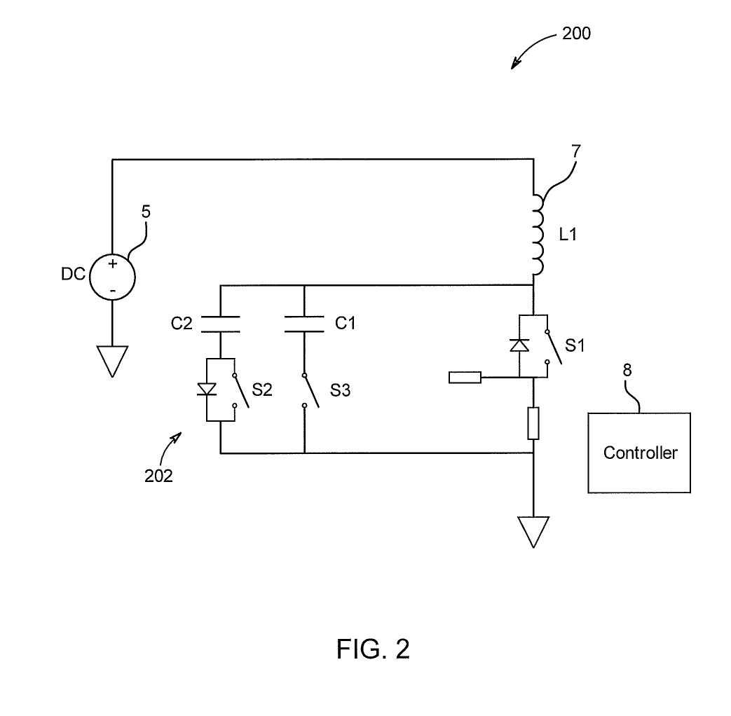

An example transmitter 200 is shown in FIG. 2. A power source 5, supplies a voltage to the transmitting coil 7. In this case the inverter 6 is embodied in a series power switch S₁, or main fly back switch. A resonance capacitor C₁ is provided in parallel with S₁, and is in series with a bidirectional switch S₃. An active clamp circuit 202 is provided in parallel with S₁, e.g.: a series combination of C₂ and S₂.

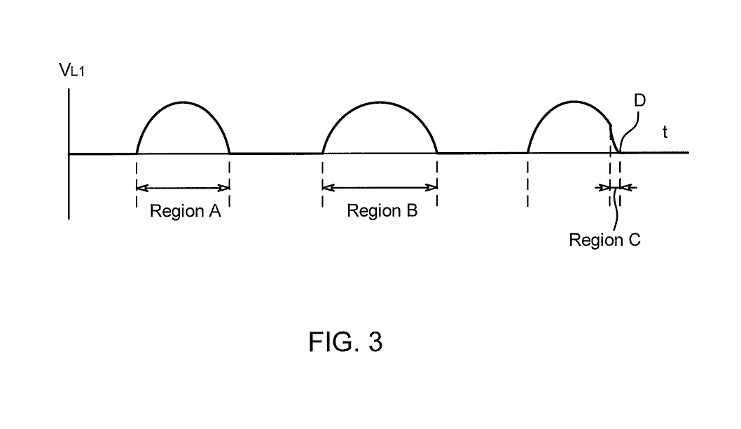

The operation of the transmitter 200 is now described with reference to FIG. 3 which shows the voltage across L₁. During resonant mode (i.e., power transfer), S₃ is on so that C₁ forms a series resonant circuit with L₁. During this mode, if S₂ is (hard) switched off then C₂ does not contribute to resonant circuit (region A). Region A provides fixed frequency zero voltage switching. Alternatively if S₂ is hard switched on when S₃ is on, C₂ is added (in parallel) to the resonant circuit which changes the operating (resonant) frequency (region B). Operating in either region A or B might be used for dynamic adjustment for minimum and maximum load conditions due to the load requirements of the receiver and/or the distance between the transmitting and receiving coils.

During start-up or any other time when resonant mode is not possible e.g.: high load, S₃ is switched off while S₂ is functionally (soft) switched. C₂ (much smaller capacitance than C₁) operates as an active clamp or snubber (region C). Operating in region C provides half-cycle power transfer at a fixed power due to the clamping at the end of the half sine-wave—where S₂ and S₃ are both switched off at point D.

In order for the ‘active clamping’ provided by the configuration of the transmitter 2 to provide effective control of the power transferred in an IPT system, the clamping or snubbing capacitor C₂ is selected to have a capacitance of an order of magnitude less than the capacitance of the resonance capacitor C₁, for example, C₂ may be in the nano farad range of capacitance and C₁ might be in the micro farad range of capacitance.

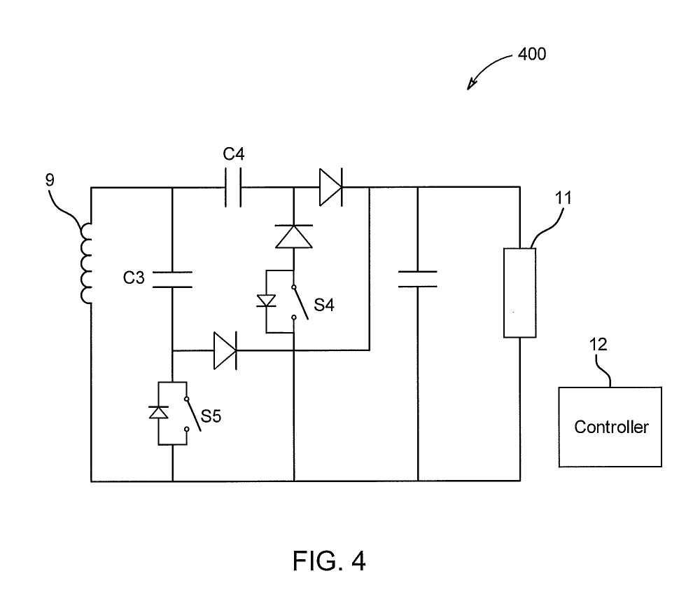

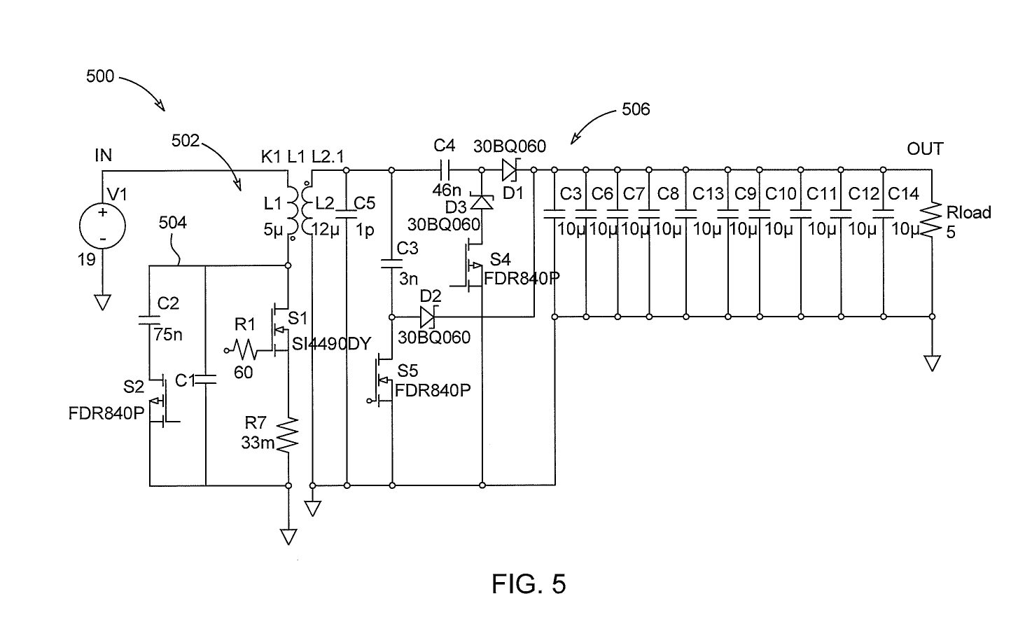

An example receiver 400 is shown in FIG. 4. This may take the form of a series resonant tank, with short circuit type power conditioning. The receiving coil L₂ is in series with resonance capacitor C₄. The power conditioning circuit 10, may be embodied by a parallel connected short circuit regulator switch S₄. A regenerative snubber 402 is connected in parallel with S₄. The regenerative snubber may take the form of a switch S₅ in series with a snubbing capacitor C₃. When S₄ is switched off during an off cycle from primary (half duty cycle e.g.: as shown in FIG. 3), a large voltage spike may occur. S₅ is opened to allow C₃ to charge and absorb or snub this spike. S₅ is closed before the end of the half cycle so that the charge from C₂ can dissipate the charged power to the load. This avoids the loss and/or heating associated with being fully snubbed. C₃ is only a small value to just allow for spike snubbing, e.g.: a unit nano farad capacitor is illustrated in the example of FIG. 5.

Depending on the application the example transmitter may be employed independently from the example receiver and vice versa. By minimising the number of switches and/or inductors the size, cost and/or complexity of the transmitter and/or receiver may be minimised.

A further example circuit 500 is shown in FIG. 5. The transmitter 502 includes transmitting coil L₁, and main switch S₁. An active clamp circuit 504 includes capacitor C₂ and switch S₂. In operation S₂ closes when S₁ opens to absorb any resulting voltage spike in C₂. S₁ stays open until the voltage across S₂ reduces to zero, allowing S₁ to switch on with zero voltage.

Resonance capacitor C₁ is connected in parallel with S₁ to provide a series resonant tank with L₁ when S₁ is open.

The receiver 506 includes receiver coil L₂, capacitor C₄ and switch S₄. The switch S₄ is used to regulate the power delivered to the load. When S₄ is closed C₄ is charged by the positive voltage across L₂. When S₄ is open C₄ discharges into the load R_{load}. Thus the duty cycle of S₄ determine the power delivered to the load, which allows the control of S₁ of the transmitter 200 to be “open loop” i.e. decoupled from the receiver output. S₅ and C₃ operate as a regenerative snubber to avoid voltage spikes when S₄ switches off.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power transfer transmitter comprising:
a transmitting coil;
a main flyback switch in series with the transmitting coil; and
an active snubber circuit connected in parallel with the main flyback switch;
wherein the main flyback switch and the active snubber circuit are configured to provide substantially zero voltage switching.

2. The transmitter in claim 1 further comprising a resonant capacitor connected in parallel with the main flyback switch configured to form a series resonant circuit with the transmitting coil.

3. The transmitter in claim 2 further comprising a capacitor switch connected in series with the resonance capacitor.

4. The transmitter in claim 3 wherein the active snubber comprises a snubber switch in series with a snubber capacitor.

5. The transmitter in claim 4 wherein the snubber capacitor has a substantially lower capacitance than the resonant capacitor.

6. The transmitter in claim 5 wherein the snubber switch is configured to switch off when the capacitor switch is on.

7. A inductive power receiver comprising:
a resonant tank including a receiving coil and a resonance capacitor;
a power regulating circuit, and
a regenerative snubber connected to the power regulating circuit.

8. The receiver in claim 6 wherein resonant tank comprises the receiving coil connected in series with the resonance capacitor.

9. The receiver in claim 6 wherein the power receiving circuit comprises a short circuit controlled switch in parallel with a load.

10. The receiver in claim 8 wherein the regenerative snubber comprises a switch in series with a capacitor.

11. The receiver in claim 9 wherein the regenerative snubber is connected in parallel with the short circuit controlled switch.
